(19) United States
(12) Patent Application Publication
(10) Pub. No.: US 2025/0313706 A1
(43) Pub. Date: Oct. 9, 2025

(54) NEAR-INFRARED LIGHT CURABLE AQUEOUS COATING COMPOSITION

(71) Applicant: ACTEGA GmbH, Wesel (DE)

(72) Inventors: Bernd Strehmel, Krefeld (DE); Lukas Appelhoff, Krefeld (DE); Thomas Brömme, Berlin (DE); Nicolas Hornemann, Wesel (DE); Elina Oks, Wesel (DE)

(21) Appl. No.: 18/872,903

(22) PCT Filed: May 30, 2023
(86) PCT No.: PCT/EP2023/064406

§ 371 Date: Dec. 9, 2024

(30) Foreign Application Priority Data
Jun. 15, 2022 (EP) 22179081.9

(51) Int. Cl. C09D 7/63; C09D 11/101; C09D 11/102

(52) U.S. Cl. CPC C09D 7/63; C09D 11/101; C09D 11/102

(57) ABSTRACT

The present invention relates to an aqueous coating composition (T) comprising: a reactive compound (M) containing at least one free radically polymerizable double bond, a cyanin (C) and an iodonium salt (O), wherein at least a partial quantity of the cyanin (C) and of the iodonium salt (O) were dissolved in a contained aqueous phase (A) comprising at least 40 wt. % water.

The invention concerns an aqueous coating composition, its use, a process for treating a substrate with the coating composition and an (intermediate) industrial product.

Conventionally, coatings have been formed from solutions of the polymer binders in organic solvents. As the coating cures, the solvents evaporate into the atmosphere. This is economically disadvantageous due to the high costs of these solvents, but more importantly, these solvents also cause pollution of the atmosphere and health hazard to people handling the products. Accordingly, alternatives to conventional solvent-based products are needed. Some efforts have been directed to coatings from polymer dispersions in water. Economically, the use of water is advantageous and, in addition, water does not pollute the atmosphere when it evaporates from the coating. Thus, water-based inks and coatings are a growing market due to the environmental pressure. Traditionally, water-based inks or coatings essentially contain water and polymeric binder.

However, typical aqueous coating compositions comprise not only polymer binder but also reactive (chemical) crosslinker which causes (additional chemical) curing by thermal activation. A disadvantage of these systems, however, is that such thermal curing is normally relatively slow and requires high temperatures (e. g. a special oven has to be used). It restricts therefore also the use of temperature sensitive substrates; that is for example paper or wood.

Likewise known are aqueous coating compositions which cure physically, corresponding to a curing of the coat by filming (by mere evaporation of the water). In systems of this kind, often no crosslinking agents are used. However, for many applications this physical curing has to be assisted by chemical crosslinking in order to provide the required mechanical properties. In many cases it is advantageous to avoid time and energy consuming thermal crosslinking (curing).

Substantially more rapid is the curing of coatings based on radiation-curable aqueous dispersions which are curable by “chemical drying” (crosslinking initiated by radiation) and “physical drying” (evaporation of water). The curing by radiation of an aqueous polymer dispersion is e. g. described in EP 277 29 17 A.

Radiation-cured aqueous coatings are e. g. used as overprint varnishes. The advantages of printing with radiation-curing printing inks and coatings are rapid spontaneous polymerization (the typical crosslinking/curing mechanism) after irradiation with a radiation source and the good printability also on non-absorbent substrates.

For many applications, such as in wood/furniture or plastic coatings, considerable initial physical drying plays a particularly important role after the water has been evaporated and before the radiation cures.

Especially in clear coats and in many printing inks is advantageous to avoid “colored ingredients” in order to provide a sufficient non-visibility (which indicates that it is not visible to naked eye). However, many photo initiator systems used in said radiation-curable aqueous dispersions show an intensive absorption in the visible range so that the applicability of such dispersions is limited accordingly.

In the context of the above, the object underlying the present invention is to provide a radiation-curing aqueous coating system, which meets high demands both in economic/environmental terms and in terms of processability and product quality.

The solution to this object is an aqueous coating composition (T) comprising:
i) a reactive compound (M) containing at least one free radically polymerizable double bond,
ii) a cyanin (C) and
iii) an iodonium salt (O),
wherein at least a partial quantity of the cyanin (C) and of the iodonium salt (O) were dissolved in a contained aqueous phase (A) comprising at least 40 wt. % water.

The aqueous coating according to the present invention has to be deemed as to be environmental and economic attractive because water is the basic ingredient. It is important that no (co-)solvents (especially such which are soluble in water) are necessary. As (co-)solvents should be deemed (per definition) only co-solvent or solvent compounds which do not have a radically polymerizable group. Co-solvent should point out that the relevant solvent has high solubility in water—so that it might be deemed as to be a co-solvent of water (part of the aqueous phase). However, there are also solvents with nearly no solubility in water (in a dispersion not or nearly not part of the aqueous phase). Such solvents and also the mentioned co-solvents (soluble in water) should be both subsumed to (co-)solvents.

Thus, reactive compound (M) species should not be subsumed to (co-)solvents. Such (co-)solvent species generally do not work as binder components but are often volatile components which should be avoided because of regulatory reasons.

However, reactive diluents (substances which reduce the viscosity and become part of the lacquer or coating during its subsequent curing via free radical polymerization) should be subsumed to (M).

The contained reactive compound (M) serves that the aqueous coating is not only physically but also chemically curable. This provides improved mechanical properties of the dried coating.

The used photo-polymerization initiator system provided by the iodonium salt (O) and the cyanin (C) shows an intensive absorption in the near-infrared but only a weak absorption in the visible range. This might be seen as to be a contribution to avoid “colored ingredients” in order to provide a sufficient non-visibility: this opens application possibilities for many clear coat and printing applications.

Said photo-polymerization initiator system works as an efficient free-radical “provider” for the free-radical polymerization of the reactive compound (M) containing at least one free radically polymerizable double bond.

The mere absorption of the near-infrared light on the one hand and the free-radical polymerization (generation of reaction heat) on the other hand (both) provide a considerable amount of heat. Said heat generation during the processing of the coating is important for a rapid physical drying (evaporation of the water) so that the coating might be also used as a printing ink, even in rapid printing processes. Generally, the fast physical drying (even without an additional thermal curing measurement, like an oven treatment) has to be deemed as to be an important economical aspect. Furthermore, in case the coating is provided as an aqueous dispersion the generated heat allows a sufficient film building. Especially because of said intensive physical drying the coating might be applied also on non-absorbent substrates.

According to a preferred embodiment the aqueous coating composition according to the present invention is provided as an aqueous dispersion in which the aqueous phase (A) is the continuous phase which comprises dispersed particles of a non-aqueous phase (B).

The aqueous dispersion might be a secondary dispersion.

According to a special embodiment the dispersion might be provided as a polyurethane dispersion in which a polyurethane polymer resin containing radical polymerizable groups (or corresponding oligomers) is dispersed in water. Typically, such dispersion types contain urethane (meth)acrylates as the component (M).

As already indicated above the aqueous dispersion according to the present invention does not need (co)-solvents (the expression co-solvent should emphasize that it is an another solvent in addition to water). Furthermore, it can be said that (co-)solvents are not only not necessary, but should even be avoided because of the reasons already discussed above. Co-solvents species mixable with water in any proportion (part of the aqueous phase) are often used as a solubilizer (for example butyl glycol), but which are not needed according to the present invention.

According to a preferred embodiment the aqueous phase contains less than 15, preferably less than 5 wt.-%, more preferably no (co-)solvent.

The reduction of the amount of the (co-)solvent (preferably its entire absence) means that the amount of the water in the aqueous phase (A) increases. As already discussed above, a high amount of water is advantageous because of environmental and also economical reasons.

Preferably, the contained aqueous phase comprises 40-98, preferably 70-90 wt. % water.

Typically, the aqueous phase contains less than 40, preferably less than 25 wt. % of such components which cannot be subsumed to one of the following components: water, a reactive compound (M), cyanin (C) and iodonium salt (O). Per definition species of the reactive compound (M) cannot be deemed as to be solvents or co-solvents (both subsumed to (co-)solvents) as already said above.

The initiator system applied according to the present invention contains iodonium salt (O) and cyanin (C) (likely working as an initiator sensitizer). Normally, it is preferred that the aqueous phase (A) contains a sufficient amount of both components. Thus, a sufficient solubility of both components in water is generally advantageous. A higher amount of said components in the (a) non-aqueous phase of a dispersion is generally not advantageous (might e. g. provide stability problems of the dispersion).

Thus preferably, the aqueous coating composition according to the present invention contains 0.05-3.00 wt. %, preferably 0.50-2.00 wt. % iodonium salt (O) and 0.005-0.500 wt. %, preferably 0.01-0.50 wt. % cyanin (C).

Preferably, the molar proportion of (O) to (C) in the aqueous phase (A) is 5-70, preferably 30-50.

Typically, at least 60 wt.-% of the species of (C) have a structure according to I, II, III and/or IV:

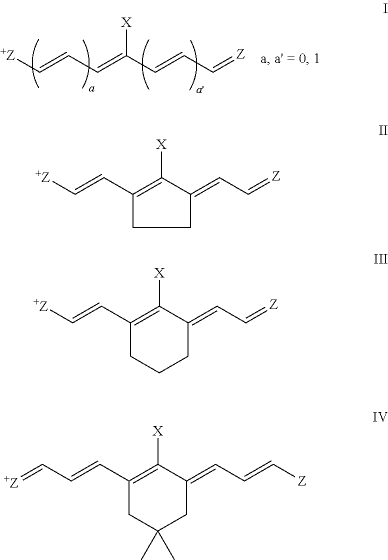

where a and a′ are independently of each other 0 or 1,
⁺Z is independently represented by an organic group containing a quarternary ammonium cation,
Z is independently represented by an organic group containing a tertiary amino moiety,
X is independently represented by an organic moiety, Cl or H.

In this connection (referring to the formulas above) the following substitution possibilities are preferred (independently of each other):

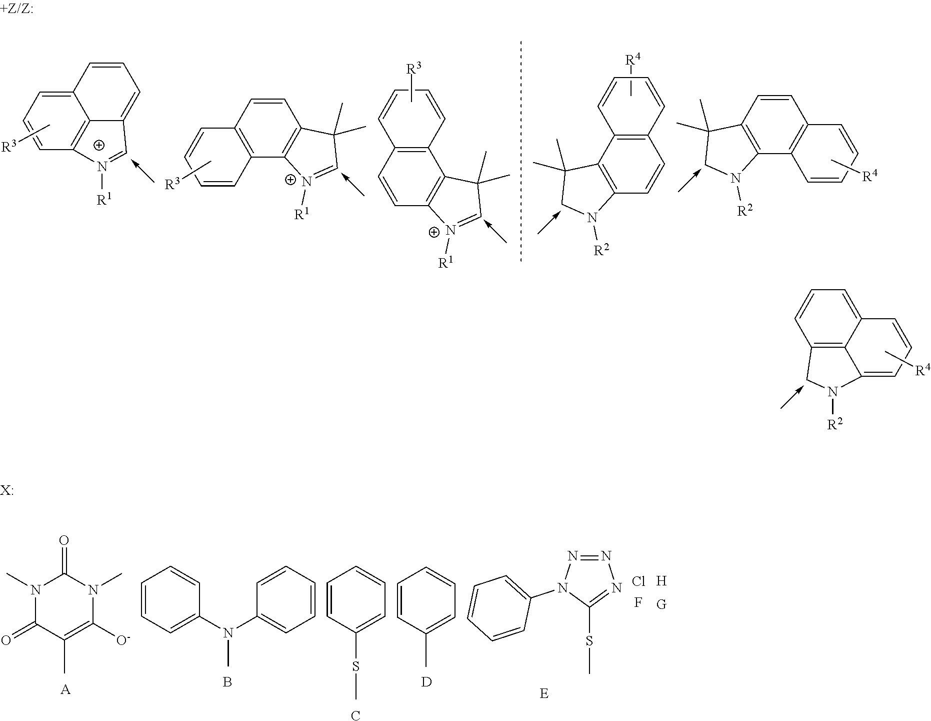

R¹ and R² might be independently represented by a linear or branched alkyl group, —(CH₂—CH₂—O)ₙ—CH₃(n=1-6), —(CH₂—CH₂—CH₂)—SO₃—, —(CH₂—CH₂—CH₂—CH₂)—SO₃⁻, —(CH₂—CH₂—CH₂)—N⁺(CH₃)₃;

R³ and R⁴ might be independently represented by H, Cl, Br, O-Alkyl, A-alkyl-Aryl, O-Aryl, S-Alkyl, S-Aryl, —SO₃—, —N⁺(CH₃)₃.

(Terminal) Substituents (moieties) not mentioned in the formulas above (only expressed as a terminal binding-) are (represented independently of each other) generally organic groups or hydrogen; preferably hydrocarbon or ether groups.

A single cyanin species to be used is: 5-(6-(2-(1,1-Dimethyl-3-(4-sulfobutyl)-1H-benzo[e]indol-2(3H)-ylidene)ethylidene)-2-(2-(1,1-dimethyl-3-(4-sulfobutyl)-1H-benzo[e]indol-3-ium-2-yl)vinyl)cyclohex-1-en-1-yl)-1,3-dimethyl-2,6-dioxo-1,2,3,6.

The iodonium salts (O) used might be according to the following general formula:

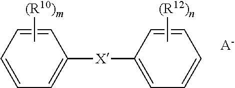

In the above formula R¹⁰ and R¹² each independently represents an organic group (e. g. an alkyl group) having preferably 1 to 6 carbon atoms; m and n is independently represented by 1,2,3,4 or 5. A-represents the corresponding anion.

Typically, at least 60 wt.-% of the cationic species of (O) are of the type alkyl and/or alkyloxy substituted diaryl iodonium. In this connection the following alkyl and/or alkyloxy types are preferred:

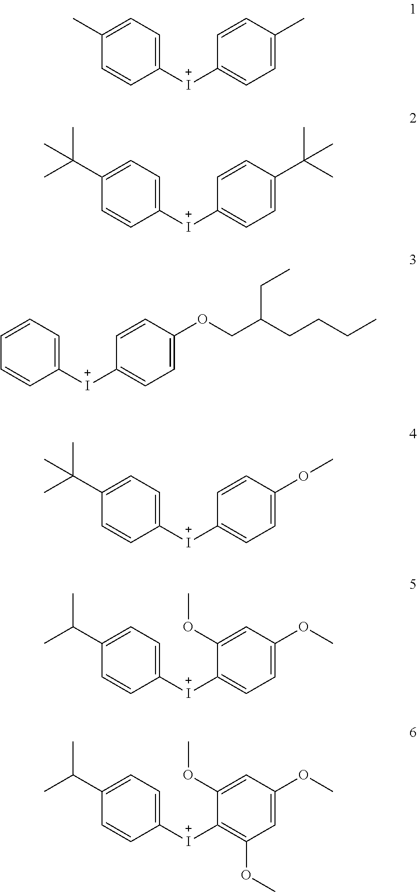

(Terminal) Substituents (moieties) not mentioned in the formulas above (only expressed as a terminal binding-) are (independently represented) generally organic groups or hydrogen; preferably (independently) hydrocarbon groups or ether groups.

Preferred is an aqueous coating composition according to the present invention, in which at least 60 wt.-% of the anionic species of (O) are anions derived from a carboxylic acid, preferably from a hydroxyl carboxylic acid, most preferably provided by lactate.

According to a special embodiment at least 10 wt.-% of the anionic species of (O) are provided by nitrate.

The use of nitrate or carboxylic species provides a better solubility in water.

Preferred salt species of (O) often have a sufficient solubility in water, preferably 30 g/l, more preferably 50 g/l (measured at 20° C.). Normally, at least 60 wt. % of the species of (O) which are contained in the aqueous coating composition (T) have a solubility in water of 0.5 g/l, more preferably 5 g/l (measured at 20° C.).

Suitable species are for example: Alky substituted diphenyl iodonium (as cation), 4-Isopropyl-4′-methyldiphenyl iodonium (as cation), Bis(p-tert-butylphenyl) iodonium lactate (as salt), Bis[4-(tert-butyl) iodonium lactate (as salt).

However, also a good solubility of the cyanin (C) in water is generally advantageous. Thus, according to a preferred embodiment at least 60 wt.-% of the species of the cyanin (C) and at least 60 wt.-% of the species of the iodonium salt (O) each have a water solubility of at least 30 g/l, preferably of at least 50 g/l, at 20° C.

According to a preferred embodiment the aqueous coating according to the present invention is curable by near-infrared light electromagnetic radiation.

Typically, the weight proportion of (M) to (C) is 5-70, preferably 30-50.

Species of the reactive compound (M) contain at least one (free radically polymerizable) double bond so that they might be polymerized (reactive concerning free radical polymerization).

Preferably, at least a partial quantity of the species of the reactive compound (M), preferably at least 70 wt. %, more preferably at least 90 wt. %, are contained in the non-aqueous phase (B). In corresponding dispersions often about 100 wt. % of the species of (M) are contained in the non-aqueous phase.

Normally, at least a partial quantity of the species of the reactive compound (M), preferably at least 60 wt. %, contain at least two free radically polymerizable double bonds. This enables an intensive crosslinking concerning the chemical curing.

Preferably, at least a partial quantity of the species of reactive compound (M), preferably at least 60 wt. %, contain at least one (meth) acryloyl group, preferably at least one acryloyl group. These groups provide a sufficient reactivity in respect to free radical polymerization which is especially important in connection with the use in (rapid) printing applications.

Often (especially if applicated in a rapid printing procedure), at least 80 wt.-% of the species of (M) contain at least one acryloyl group (H₂C═CH—C(=50)—)).

Bifunctional (meth)acrylates might be used. However, in applications which need to have a low viscosity higher amounts of mono (meth)acrylates might be used.

Some reactive components (M) which are commonly used as monomers include:

Monomers comprising one polymerizable group such as: alkyl methacrylate, tetrahydrofufuryl methacrylate, isodecyl methacrylate, 2(2-ethoxyethoxy) ethylacrylate, stearyl acrylate, tetrahydrofurfuryl acrylate, lauryl methacrylate, stearyl methacrylate, lauryl acrylate, 2-phenoxyethyl acrylate, 2-phenoxyethyl methacrylate, glycidyl methacrylate, isodecyl acrylate, isobornyl methacrylate, isooctyl acrylate, tridecyl acrylate, tridecyl methacrylate, caparolactone acrylate, ethoxylated nonyl phenol acrylate, isobornyl acrylate, polypropylene glycol monomethacrylate, hexadecyl acrylate, monomethoxy tripropylene glycol monoacrylate, monomethoxy neopentyl glycol propoxylate monoacrylate, B-carboxyethyl acrylate, and oxyethylated phenol acrylate;

Monomers comprising two polymerizable groups such as: triethylene glycol dimethacrylate, ethylene glycol dimethacrylate, tetraethylene glycol dimethacrylate, polyethylene glycol dimethacrylate, 1,3 butylene glycol diacrylate, 1,4 butanediol diacrylate, 1,4 butanediol dimethacrylate, diethylene glycol diacrylate, diethylene glycol dimethacrylate, 1,6 hexanediol diacrylate, 1,6 hexanediol dimethacrylate, neopentyl glycol diacrylate, neopentyl glycol dimethacrylate, polyethylene glycol dimethacrylate, polyethylene glycol diacrylate, tetraethylene glycol diacrylate, triethylene glycol diacrylate, 1,3 butylene glycol dimethacrylate, dipropylene glycol diacrylate, tripopylene glycol diacrylate, polyethylene glycol diacrylate, ethoxylated bisphenol A dimethacrylate, ethoxylated bisphenol A diacrylate, propoxylated neopentyl glycol diacrylate, ethoxylated neopentyl glycol diacrylate, ethoxylated tripopylene glycol diacrylate, monomethoxy trimethylolpropane ethoxylate diacrylate;

Monomers comprising three polymerizable groups, such as: tris(2-hydroxy ethyl) isocyanurate trimethacrylate, trimethylol propane triacrylate, trimethylol propane trimethacrylate, tris(2-hydroxy ethyl)isocyanurate triacrylate, ethoxylated trimethylol propane triacrylate, propoxylated glycerol triacrylate ditrimethylol propane triacrylate, pentaerythritol triacrylate, and propoxylated trimethylolpropane triacrylate; and, (4) multi-functional monomers, such as: pentaerythritol tetraacrylate, di-trimethylol propane tetraacrylate, dipentaerythritol pentaacrylate, ethoxylated pentaerythritol tetraacrylate, and pentaacrylate ester.

Other reactive components (M) that are not considered as monomers are reactive oligomers selected typically from acrylated or methacrylated polyols. Examples include epoxy type acrylates such as Bisphenol A diglycidylether diacrylate, polyester acrylates and metharylates, urethane acrylates and methacrylates, dendrimeric acrylates and methacrylates, polyether acrylates and methacrylates, acrylated acrylics or amine-modified polyether acrylates.

The present invention is also directed to a process for treating a substrate with a coating composition, comprising the steps of:
(a) providing a radiation receptive layer, at least partially covering said substrate,
(b) treating the radiation receptive layer by electromagnetic radiation, by providing light, ranging from 400-3000, preferably from 700-1100 nm, wherein
   the radiation receptive layer provided in step (a) contains or consists of an aqueous coating composition (T) as described above.

Typically, the process according to present invention is performed under exclusion of oxygen, preferably by purging with inert gas or by alternative methods known by the skilled person. This might be done in order to avoid the inhibition of free radical polymerization because of atmospheric oxygen.

According to a special embodiment the process according to the present invention is designed as a printing process.

Typically, the radiation receptive layer provided in step (a) has a thickness between 0.1-200, preferably between 0.2 μm and 20 μm, where the thickness is determined via gravimetry. In case of the application of thicker layers the irradiation effect might be not sufficient so that especially the chemical curing remains not satisfactory.

The present invention also relates to an (intermediate) industrial product which is producible by a process as described above.

Furthermore, the present invention concerns also the use of a coating composition as described above as a primer coating, wood coating or as a printing ink.

The present invention is further described below by using examples.

### EXAMPLES

### Description of Examples 1-14 and Comparative Examples Comparative 1-2 Reactivity

39.6 mg of iodonium salt with the respective anion and 1.36 mg of Sensitizer (Sens) were dissolved in 6.7 g of water. 3.8 g of a crosslinkable polyester-polyurethane dispersion (40% in aqueous solution) comprising reactive double bonds were then added to the initiator mixture and homogenized. The reactive coating produced in this way has a non-volatile content of approximately 14.4% by weight. The concentration of the iodonium salt was chosen so that it makes up about 2.6% by weight, based on the solid resin mass. The weight amount of Sens was selected so that it presented approximately 0.09% by weight based on the solid resin composition. Furthermore, the coating described was applied to a glass substrate with a bar coater resulting in a thickness of 80 μm (wet). It was then exposed under inert gas (N₂) for 2 min with a near-infrared LED (intensity: 1 W/cm²; exposure area: 9 cm×1.5 cm; λₘₐₓ=820 nm) to dry and simultaneously chemically crosslink. The conversion of double bonds after exposure was determined by FTIR spectroscopy.

In addition, the reactivity of the reaction mixture could also be confirmed by differential scanning calorimetry (photo-DSC). Here, 20 μl of aforementioned solution were added in a DSC-pan, air dried and exposed with the LED described above. It exhibited an intensity of 200 mW/cm². The height of the exothermic peak in the DSC-signal (W/g) relates to the reactivity often also called as Rₚ^{max}. The higher the signal, the higher the intensity.

### Structures of Sensitizers Used

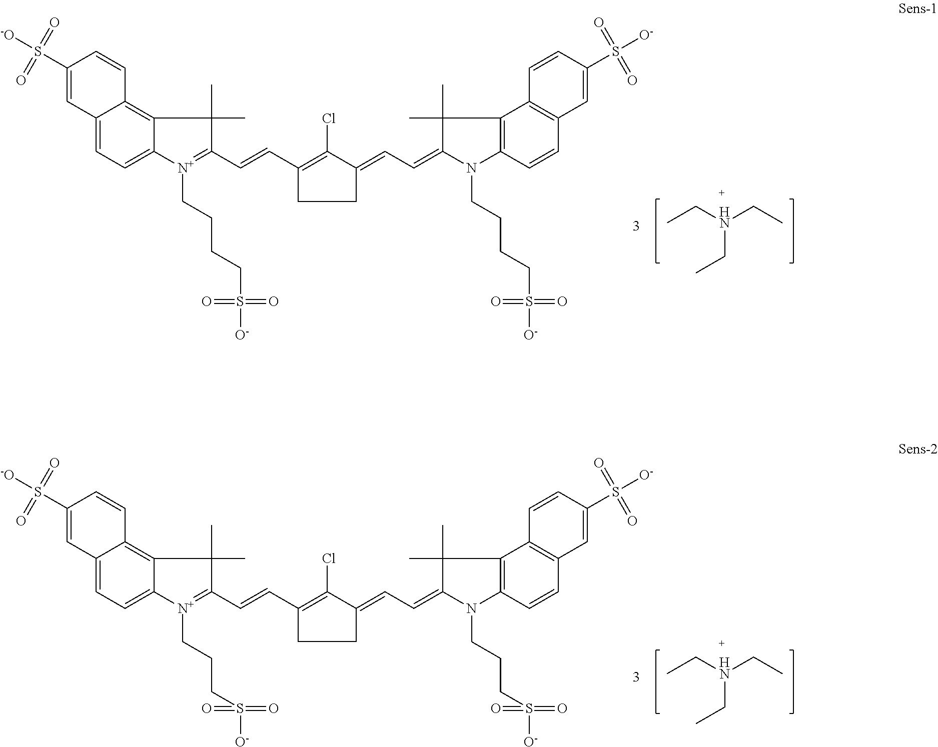

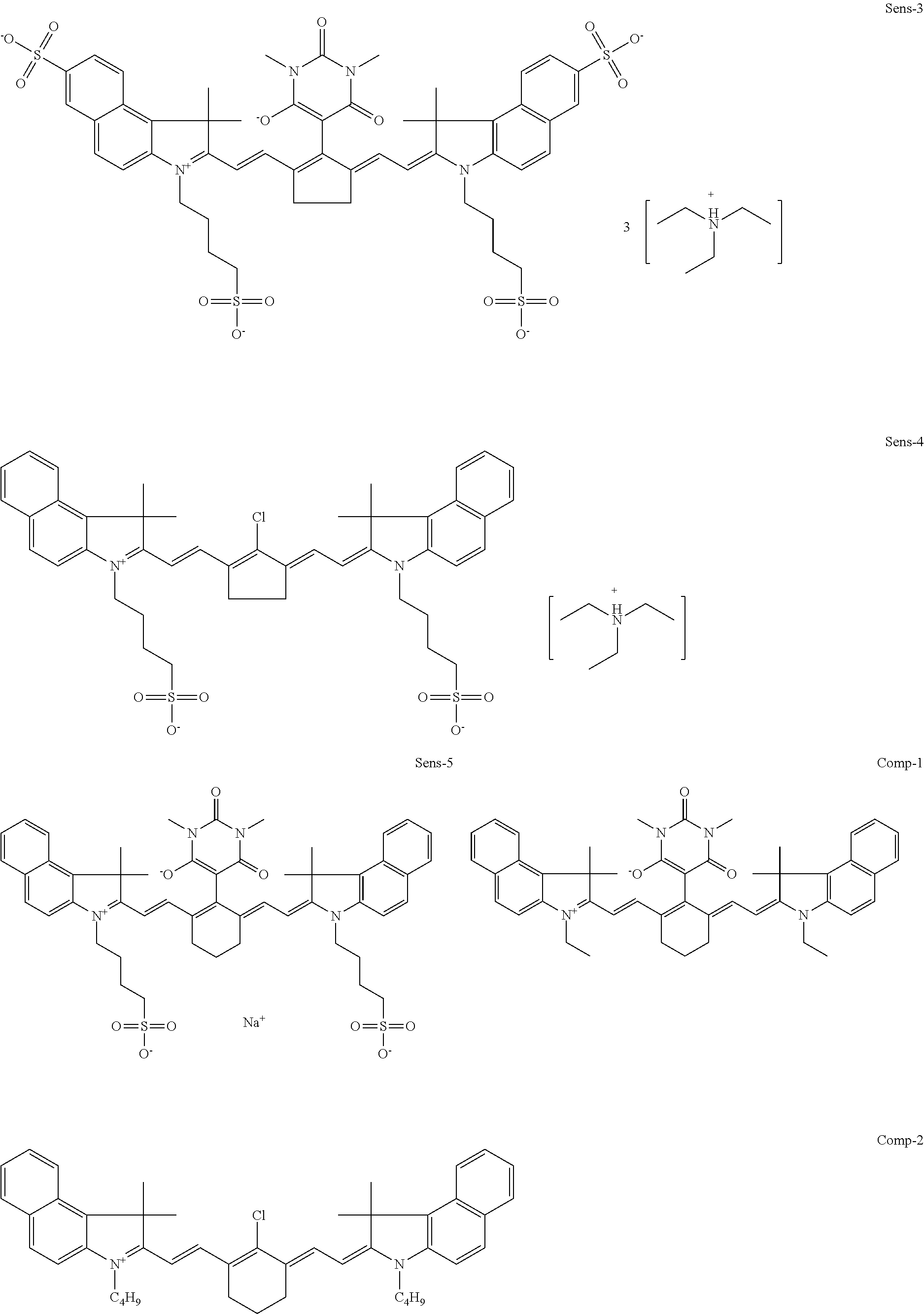

### Iodonium Cations (Icat)

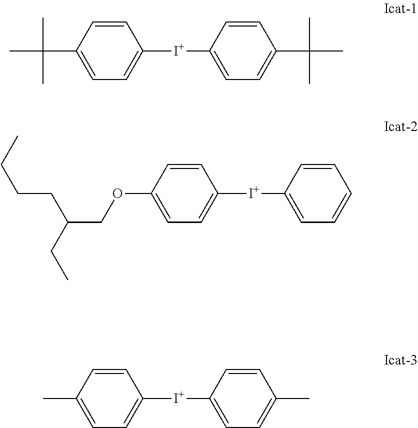

### Anions (X⁻):

a: CH₃—CH(OH)COO⁻; b: NO₃⁻; c: Cl⁻; d: PF₆⁻; e: SbF₆⁻, f: (CF₃SO₂)₂N⁻; g: Al(O-t-C₄F₉)₄, h: (Ph)₂—C(OH)—COO—

### Solubility of the Components

### Iodonium Salts:

The solubility of the lodonium salts was determined with GC-MS. The salt quantitatively decomposes >230° C. Sample preparation started with stepwise dissolution of the salt in the monomer (starting with 50 mg salt in 500 μL monomer, the amount of iodonium salt was increased with 50 mg steps until the monomer was oversaturated with the salt, which can be visually seen by the appearance of two phases). The solution was transferred in an ultrasonic bath for 10 min, and centrifuged to separate the non-dissolved iodonium salt. The liquid phase was filtered to obtain the saturated monomer solution. Subsequently, the solution obtained was diluted with methanol. This solution was transferred to the GC-MS where it was injected into the injector. The injection temperature was set at 30° C. and increased after 0.05 min isothermal driving to 320° C. applying a heating range of 12° C.·s⁻¹. The conditions in the GC-MS were chosen so that the iodonium salt decomposited into the corresponding aryl iodide as identified in the mass spectrum. This was quantified using defined concentrations of iodonium salt, which were injected into GC-MS equipment resulting a calibration curve for each iodonium salt.

### Cyanines/NIR Absorber:

100 mg NIR-sensitizer were transferred into 1 g monomer resulting in a saturated solution in water comprising non-dissolved parts of the sensitizer. This was taken in an ultrasonic bath for 10 min, centrifuged to separate non-dissolved sensitizer. The solution obtained was finally filtrated to separate possibly available solid sensitizer stuff. 20-100 mg (depending on sensitizer dissolution) of this solution was diluted with 10 mL water. An UV-Vis-NIR spectrum was taken from this solution in a cuvette (d=10 mm) resulting in quantitative information regarding the dissolved sensitizer in the monomer using the extinction coefficient of the sensitizer in water.

### Examples 1-16

| example | Binder (M) | Sens | Icat | X- |
|---|---|---|---|---|
| 1 | Aqueous Dispersion* | Sens-1 | Icat-1 | a |
| 2 | Aqueous Dispersion* | Sens-2 | Icat-1 | b |
| 3 | Aqueous Dispersion* | Sens-3 | Icat-1 | C |
| 4 | Aqueous Dispersion* | Sens-4 | Icat-1 | d |
| 5 | Aqueous Dispersion* | Sens-5 | Icat-1 | e |
| 6 | Aqueous Dispersion* | Sens-1 | Icat-1 | f |
| 7 | Aqueous Dispersion* | Sens-1 | Icat-1 | g |
| 8 | Aqueous Dispersion* | Sens-1 | Icat-1 | h |
| 9 | Aqueous Dispersion* | Sens-1 | Icat-2 | a |
| 10 | Aqueous Dispersion* | Sens-1 | Icat-3 | b |
| 11 | Aqueous Dispersion* | Sens-2 | Icat-1 | a |
| 12 | Aqueous Dispersion* | Sens-3 | Icat-1 | a |
| 13 | Aqueous Dispersion* | Sens-4 | Icat-1 | a |
| 14 | Aqueous Dispersion* | Sens-5 | Icat-1 | a |
| 15 | PEGDA** aqueous solution | Sens-5 | Icat-1 | a |
| 16 | PEGDMA*** aqueous solut. | Sens-5 | Icat-1 | a |
| 17′ | TPGDA**** | Comp-1 | Icat-1 | a |
| 18′ | TMPTA***** | Comp-2 | Icat-1 | a |

*based on Polyester-Polyurethane copolymer containing curable acrylate moieties
**Polyethylenglycoldiacrlyate (Mₙ = 575 g/mol); 14.4% in water
***Polyethylenglycoldimethacrylate (Mₙ = 550 g/mol); 14.4% in water
****Tripropyleneglycolediacrylate without water (neat monomer)
*****Trimethylolpropyleneglycolediacrylate without water (neat monomer)

Examples 17′ and 18′are comparative examples because there is no use of water.

### Results Referring to the Table Above:

(W/g)

| | Solub- | Solub- | | |
|---|---|---|---|---|
| | ility of | ility of | | |
| | Sens | Icat X⁻ | Conversion | Rₚ^{max} |
| example | (g/L) | (g/L) | (%) | (W/g) |
| 1 | 41 | 57 | 88 | 3.5 |
| 2 | 42 | 1.3 | 56 | 1.4 |
| 3 | 45 | 1.7 | 1 | 0.2 |
| 4 | 22 | 0.3 | 4 | 0.5 |
| 5 | 28 | 0.4 | 6 | 0.5 |
| 6 | 41 | 0.9 | 3 | 0.3 |
| 7 | 41 | 0.1 | 7 | 0.9 |
| 8 | 41 | 0.3 | 5 | 0.7 |
| 9 | 41 | 39 | 67 | 3.2 |
| 10 | 41 | 54 | 71 | 3.9 |
| 11 | 42 | 57 | 72 | 3.3 |
| 12 | 45 | 57 | 81 | 3.2 |
| 13 | 22 | 57 | 70 | 2.8 |
| 14 | 28 | 57 | 89 | 3.9 |
| 15 | 28 | 57 | 91 | 2.3 |
| 16 | 28 | 57 | 88 | 2.1 |

| | | | |
|---|---|---|---|
| 17 | 0.3 | 57 | Not compatible according to the procedure |
| | | | disclosed. film formation proceeded |
| | | | inhomogeneous |
| 18 | 0.1 | 57 | Not compatible according to the procedure |
| | | | disclosed. film formation proceeded |
| | | | inhomogeneous |

The conversion (%) relates to the degree of the converted (free radically polymerizable) double bonds

Rₚ^{max} is a measure for the maximal rate of polymerization (measured by calorimetry)

The experimental results make it clear that although the reactivity/conversions are significantly dependent on the choice (solubility) of the anion X− of the iodonium salt used, conversions can generally be achieved with all of the anions used.

Without (water) solvents at all (comparative tests 17 and 18) it does not work—for this, organic solvents would have to be used as a water substitute—which, however, should be avoided for ecological/economic reasons.

1. An aqueous coating composition (T) comprising:
i) a reactive compound (M) containing at least one free radically polymerizable double bond,
ii) a cyanin (C) and
iii) an iodonium salt (O),
wherein at least a partial quantity of the cyanin (C) and of the iodonium salt (O) are dissolved in a contained aqueous phase (A) comprising at least 40 wt. % water.

2. The aqueous coating composition according to claim 1, which is provided as an aqueous dispersion in which the contained aqueous phase (A) is the continuous phase which comprises dispersed particles of a non-aqueous phase (B).

3. The aqueous coating composition according to claim 1, in which the contained aqueous phase (A) comprises 40-98 wt. % water.

4. The aqueous coating composition according to claim 1 in which the contained aqueous phase (A) contains less than 40 wt. % of such components which cannot be subsumed to one of the following components: water, a reactive compound (M), cyanin (C) and iodonium salt (O).

5. The aqueous coating composition according to claim 1 in which the contained aqueous phase (A) contains less than 15 wt.-% (co-)solvent.

6. The aqueous coating composition according to claim 1, containing 0.05-3.00 wt. % iodonium salt (O) and 0.005-0.500 wt. % cyanin (C).

7. The aqueous coating composition according to claim 1 in which the molar proportion of (O) to (C) in the contained aqueous phase (A) is 5-70.

8. The aqueous coating composition according to claim 1 in which at least 60 wt.-% of the species of (C) have a structure according to I, II, III and/or IV: 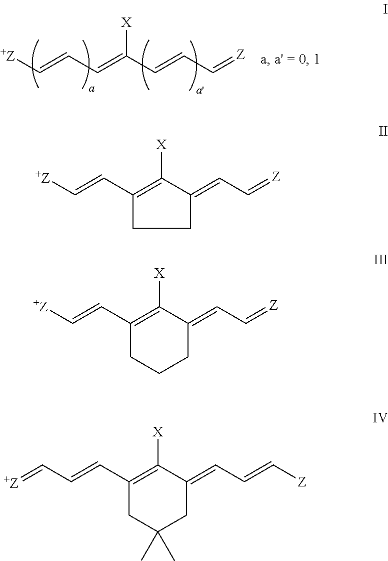
where a and a′ are independently of each other 0 or 1,
⁺is independently represented by an organic group containing a quarternary ammonium cation,
Z is independently represented by an organic group containing a tertiary amino moiety,
X is independently represented by an organic moiety, Cl or H.

9. The aqueous coating composition according to claim 1, in which at least 60 wt.-% of the cationic species of (O) are alkyl and/or alkyloxy substituted diaryl iodonium.

10. The aqueous coating composition according to claim 1, in which at least 60 wt.-% of the anionic species of (O) are anions derived from a carboxylic acid.

11. The aqueous coating composition according to claim 1, in which at least 10 wt.-% of the anionic species of (O) are provided by nitrate.

12. The aqueous coating composition according to claim 1, in which at least 60 wt.-% of the species of the cyanin (C) and at least 60 wt.-% of the species of the iodonium salt (O) each have a water solubility of at least 30 g/l at 20° C.

13. The aqueous coating composition according to claim 1, in which at least a partial quantity of the species of the reactive compound (M) are contained in the non-aqueous phase (B).

14. The aqueous coating composition according to claim 1, in which at least a partial quantity of the species of the reactive compound (M) contain at least two free radically polymerizable double bonds.

15. The aqueous coating composition according to claim 1 in which at least a partial quantity of the species of the reactive compound (M) contain at least one (meth)acryloyl group.

16. The aqueous coating composition according to claim 1 in which the weight proportion of (M) to (C) is 10000−10.

17. The aqueous coating composition according to claim 1 which is curable by near-infrared light electromagnetic radiation.

18. A process for treating a substrate with a coating composition, comprising:
(a) providing a radiation receptive layer, at least partially covering said substrate,
(b) treating the radiation receptive layer with electromagnetic radiation,
by providing light, ranging from 400-3000 nm, wherein
the radiation receptive layer provided in step (a) contains an aqueous coating composition (T) according to claim 1.

19. The process according to claim 18, which is performed under exclusion of oxygen.

20. The process according to claim 18, which is designed as a printing process.

21. The process according to claim 18, wherein the radiation receptive layer provided in step (a) has a thickness between 0.1 μm and 200 μm, where the thickness is determined via gravimetry.

22. (canceled)

23. (canceled)
